(19) United States
(12) Patent Application Publication
(10) Pub. No.: US 2018/0293679 A1
(43) Pub. Date: Oct. 11, 2018

(54) SYSTEMS AND METHODS OF A PLATFORM FOR CANDIDATE IDENTIFICATION

(71) Applicant: ColleMark LLC, Cambridge, MA (US)

(72) Inventors: Yating Bai, Watertown, MA (US); Claude Quentin Comeau, Milford, NH (US); Jose Alberto Halperin, Brookline, MA (US)

(21) Appl. No.: 16/004,883

(22) Filed: Jun. 11, 2018

Related U.S. Application Data
(63) Continuation-in-part of application No. 15/181,050, filed on Jun. 13, 2016.
(60) Provisional application No. 62/180,150, filed on Jun. 16, 2015.
(60) Provisional application No. 62/518,452, filed on Jun. 12, 2017.

(51) Int. Cl. G06Q 50/20; G06Q 50/00; G06Q 30/06; G06F 17/30

(52) U.S. Cl. CPC G06Q 50/2053; G06F 17/30867; G06Q 30/0643; G06Q 50/01

(57) ABSTRACT

The disclosure herein relates to a web-based platform for college admission officers and prospect student/applicants to connect with each other. This disclosure further relates to providing a user interface for a plurality of candidates to each populate a user profile with data items, assigning a score and a category label for each data item in each user profile, wherein a cumulative score is populated for each user profile by summing individual scores and wherein at least one top-level category is optionally assigned for each user profile, receiving a search query, through the user interface, including at least one of a desired cumulative score range, a desired score range for one or more category labels, and one or more top-level categories, and outputting a subset of the plurality of user profiles, through the user interface, wherein the subset of the plurality of user profiles match the search query.

### CLAIM TO PRIORITY

This application is a continuation-in-part application of U.S. application Ser. No. 15/181,050, filed Jun. 13, 2016 (COLL-0001-U01), which claims priority to U.S. Application No. 62/180,150, filed Jun. 16, 2015 (COLL-0001-P01).

This application also claims the benefit of the following provisional application: U.S. Application No. 62/518,452, filed Jun. 12, 2017 (COLL-0002-P01).

Each of the above-referenced applications is incorporated by reference in its entirety.

### BACKGROUND

### Field

The disclosure herein relates to a web-based platform for college admission officers and prospective students/applicants to connect with each other.

### Description of the Related Art

There are 4,599 colleges in the US, including 2-year and 4-year institutions. While some colleges struggle to fulfill their enrollment expectations drawing from sometimes meager applicant pools, applicants overflow other colleges. Millions of students apply or want to apply to American schools every year, a figure that increases significantly with each application cycle. The difficulties for schools to identify and offer applications or admission to the right pool of prospects, as well as the difficulties for students to identify the right school(s) for their academic and financial potential, may be more complex for international than for American students.

There remains a need for colleges to identify their best student candidates or prospects and for students to readily apply to the colleges of their choosing. Further, there remains a need to identify international student prospects or candidates.

### SUMMARY

The disclosure herein concerns a platform for colleges to identify student candidates and for students to obtain information about, and optionally apply, to the colleges of their choosing.

In an aspect, a method may include grouping certain categories together to form one or more top-level categories, assigning a plurality of categories to a user, determining if the plurality of categories matches the group of categories used to form the top-level category, and assigning the top-level category to the user.

In an aspect, a method of matching applicants with colleges may include providing a user interface for a plurality of users to each populate a user profile with items, assigning at least one of a score and a category label for each item in each user profile, wherein a cumulative score is populated for each user profile by summing individual scores, and wherein a top-level category is optionally assigned for each user profile based on a particular grouping of category labels, receiving a search query including at least one of a desired cumulative score range, a desired score range for a particular, one or more category labels, and one or more top-level categories, and outputting a subset of the plurality of user profiles, wherein the subset of the plurality of user profiles that match the search query. The user interface is embodied in a tangible medium (e.g., a PDA, smartphone, computer, tablet, or other computing device with input and output devices) and is directly and necessarily tied to a computing device. The user interface is accessible on different computing devices and capable of dynamically accessing user specific data stored on a network server and local device.

In an aspect, a user interface accessible on different computing devices and capable of dynamically accessing user specific data stored on a network server and local device may enable users to perform operations including submitting a search query for at least one of a desired cumulative score range for a user profile, a desired score range for one or more categories of a user profile, and one or more top-level categories, reviewing a subset of a plurality of user profiles, wherein the subset of the plurality of user profiles match the search query, and ranking the user profiles in accordance with at least one of the cumulative score range, the score range or the top-level categories. The user profile may include qualitative and quantitative information. The operations may further include communicating with one or more users based on the ranking of the user's user profile.

In an aspect, a method may include receiving user profile data from a first user at a first remote computer, at the first remote computer, accessing a user profile to update it and analyze it to generate scores, categories and top-level categories, and transmitting the scores, categories and top-level categories to a second remote computer where a second user generates rankings or other hierarchical ordering of a plurality of first users. The method may further include notifying the first user by at least one of the first or second remote computer that their user profile has been accessed, analyzed, ranked, or ordered.

In an aspect, a tangible article of manufacture having instructions stored thereon may, when executed, causes a machine to perform operations including providing a user interface for a plurality of candidates to each populate a user profile with data items, assigning a score and a category label for each data item in each user profile, wherein a cumulative score is populated for each user profile by summing individual scores and wherein at least one top-level category is optionally assigned for each user profile, receiving a search query, through the user interface, including at least one of a desired cumulative score range, a desired score range for one or more category labels, and one or more top-level categories, and outputting a subset of the plurality of user profiles, through the user interface, wherein the subset of the plurality of user profiles match the search query. The operations may further include ranking the user profiles in accordance with at least one of the cumulative score range, the score range or the top-level categories. The user profile may include qualitative and quantitative information. The operations may further include enabling communication with one or more users based on the ranking of the user's user profile. The top-level category may be identified by determining if the assigned category labels match a group of categories used to form the top-level category. Assigning the score to data items is done through the user interface by the same entity that provides the search query. The search query may be based on category labels that are missing or disproportionately under-represented in a third party group but which are represented in the plurality of candidates.

In an aspect, a computer implemented dynamic data processing method may include storing a plurality of user data received from a plurality of users in a database within a storage device, wherein each of the plurality of user data is categorized and stored in different portions of the storage device, providing a user interface to the plurality of users to each populate a user profile with individualized data content, assigning a score and a category label for each data content specific to each user profile, wherein a cumulative score is populated for each user profile by summing individual scores and wherein at least one top-level category is optionally assigned for each user profile, storing the at least one-top level category data content in a specific portion of the storage device separate from the non top-level category data, receiving a search query, through the user interface, including at least one of a desired cumulative score range, a desired score range for one or more category labels, and one or more top-level categories, retrieving the data content based on the search query, and outputting a subset of the plurality of user profiles, through the user interface, wherein the subset of the plurality of user profiles match the search query, wherein the storage device continuously updates and categorizes the data content input is received from the plurality of users.

In an aspect, a tangible article of manufacture has instructions stored thereon that, when executed, causes a machine to perform operations including providing a user interface in a marketplace for a plurality of candidates to each populate a user profile with data items, wherein each candidate separately subscribes to the marketplace and a plurality of user profiles are populated; assigning a score and a category label for each data item in each user profile, wherein a cumulative score is populated for each user profile by summing individual scores and wherein at least one top-level category is optionally assigned for each user profile; receiving a search query, through the user interface, including at least one of a desired cumulative score range, a desired score range for one or more category labels, and one or more top-level categories; and outputting a subset of the plurality of user profiles, through the user interface, wherein the subset of the plurality of user profiles match the search query. The tangible article of manufacture may further include ranking the plurality of user profiles in accordance with at least one of the cumulative score range, the score range or the top-level categories to obtain a ranking. The plurality of user profiles may include qualitative and quantitative information. The tangible article of manufacture may further include enabling communication with one or more users based on the ranking of the user's user profile. The top-level category may be identified by determining if the category label that was assigned matched a group of categories used to form the top-level category. Assigning the score to data items may be done through the user interface by an entity that provided the search query. The search query is based on category labels that are missing or disproportionately under-represented in a third-party group but which are represented in the plurality of candidates. Enabling communication is limited by a rule for accessing the marketplace, wherein the rule for accessing the marketplace relates to one or more of a pre-defined number of users, a pre-defined number of searches, a pre-defined number of search results, a total amount of time spent searching, a total amount of time, an unlimited amount of time, an unlimited number of searches, an unlimited number of search results, one or more of a certain sub-set of features, searching certain content sets, a level of functionality, a level of messaging, a level of storing results, and a level of search aid.

In an aspect, a computer-implemented system includes a user interface in a marketplace for a plurality of candidates to each populate a user profile with data items, wherein each candidate separately subscribes to the marketplace; a processor structured to assign a score and a category label for each data item in each user profile, wherein a cumulative score is populated for each user profile by summing individual scores and wherein at least one top-level category is optionally assigned for each user profile; wherein the processor receives a search query, through the user interface, comprising at least one of a desired cumulative score range, a desired score range for one or more category labels, and one or more top-level categories; wherein the processor outputs a subset of the plurality of user profiles, through the user interface, wherein the subset of the plurality of user profiles match the search query; wherein the processor ranks the user profiles in accordance with at least one of the cumulative score range, the score range or the top-level categories to obtain a ranking; and wherein the search query is based on category labels that are missing or disproportionately under-represented in a third-party group but which are represented in the plurality of candidates. The user profile comprises qualitative and quantitative information. The system further includes the processor structured to enable communication with one or more users based on the ranking of the user's user profile. The top-level category is identified by determining if the category label that was assigned matches a group of categories used to form the top-level category. Assigning the score to data items is done through the user interface by an entity that provided the search query. Communication is limited by a rule for accessing the marketplace, wherein the rule for accessing the marketplace relates to one or more of a pre-defined number of users, a pre-defined number of searches, a pre-defined number of search results, a total amount of time spent searching, a total amount of time, an unlimited amount of time, an unlimited number of searches, an unlimited number of search results, one or more of a certain sub-set of features, searching certain content sets, a level of functionality, a level of messaging, a level of storing results, and a level of search aid.

These and other systems, methods, objects, features, and advantages of the present invention will be apparent to those skilled in the art from the following detailed description of the preferred embodiment and the drawings. All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a method of categorizing users according to an embodiment;

FIG. 2 depicts a method of matching applicants with colleges according to an embodiment; and

FIG. 3 depicts a marketplace web interface for selecting desired services.

### DETAILED DESCRIPTION

In an aspect, the disclosure herein concerns a convenient, efficient, and user-friendly platform for colleges to identify student candidates and for students to identify, learn about, and/or apply to the colleges of their choosing. The platform may alternatively be described as a site, website, web page, system, and/or marketplace. For applicant-students, the platform serves as a marketplace that provides a one-stop-shopping to find information about the schools of interest and also identify other schools (yet unknown to them) that could better fit their individual profiles, interests and potential beyond the limited information provided by test scores. In addition to rankings for colleges and programs, in-depth meaningful information about the many schools to which a student could apply, such as those with a favorable chance of admission success for the student, is provided by the marketplace. The site further provides “How To” videos and web pages to help the students understand the college application and acceptance process, including information about college costs, FAFSA funding, site visits, application tips, links to third party resources, and the like.

In an embodiment, a marketplace catering to both colleges and student/candidates may enable both parties to meet their needs. For college admission officers, the marketplace may provide a convenient, efficient and user-friendly tool to identify, among large pools of national and international applicants, those student-candidates that better fit their school academic profile, size, philosophy, environment and financial requirements. Admission officers can actively search student applicant profiles stored in a database. This search will be based not only on admission officers' defined criteria but also on algorithms designed to help colleges identify the students that best meet their criteria and have a higher probability of success in the application process. College administrators and admissions officers may use the system to create various predefined levels of offer packages for students, custom offer, defined general search criteria for searching a pool of candidates, create additional student search criteria beyond predefined parameters, obtain a list of attractive students based on a search, review the search list and full profiles for candidates and make offers (e.g. invitation to apply, waiving of fees, offer of scholarships), send offer messages to candidates, create and receive messages to and from students, and the like. Prospective students and candidates can search for schools, create lists of schools in which they are interested, fill out a profile including standard admissions requests and non-standard data and input requested by the system, communicate with admissions officers, accept or reject offers, block communication from schools in which they are not interested, and the like.

In some embodiments, interaction of the student with the system may be shared with or searched by the college administrator, such as how many “How To Videos” the student watched, what colleges the student has marked as the ones they are interested in, and the like. Thus, by the student preparing a detailed user profile including academic performance data, work experience, out-of-school sports, interests, travel experience, etc., it may be used by the student to search for colleges of interest, but it may also be used by college administrators or officers to identify students of interest.

Students may search for colleges or institutions using specific search criteria to obtain a list of colleges that match their criteria. The system may provide guidance customizing a college search via questions that create a unique search query. This search is done by using server side databases and specialized database queries (filters) that sometimes use the system's enhanced questions and logic. These searches are done on a database of colleges that has additional information about the college, college students and information about the surrounding area. This may be combined with historic data to augment the results. The system asks non-traditional questions of students to help make a good match beyond the simple criteria a student would normally use. For example, instead of just asking for the student's SAT score, the system may also ask questions such as: “How do you feel this score represent your knowledge in this field. Answer from 1 Very well to 5 Not at all.” or “Have you traveled abroad?”

Non-traditional questions may be used to populate the user profile. The system web site has the student fill out a “Profile” that then becomes accessible to admission officers who can search the applicant pool to find those student candidates that best fit their college admission rules and philosophy. The student's profile may include both typical student facts such as GPA, SAT scores as well as special facts such as “Have you traveled outside your state?”, “Do you have any part-time work experience?”, “What type of charity work have you done?”, “Have you been a baby-sitter, had a newspaper route, etc.” These may include personal traits, attitudes, opinions, and behaviors. These non-typical student admission questions combined with typical admission data can greatly help college administrators evaluate the student, as well as aid the student in searching for colleges. For example, college administrators/officers may edit the school's profile to list certain information that can be searched or matched by students. Such information may be standard (e.g. size, tuition, programs of study, selectivity, athletics, volunteer opportunities, arts offerings, location, social opportunities, etc.) or may be non-typical, such as for example, the school indicating a high proportion of students who indicate an interest in adventure travel, or a large number of students who have taken an AP science and an AP art exam.

Using a user interface, prospective students and candidates can input data to a profile related to a plurality of types of information. The user interface may be accessible on different computing devices and capable of dynamically accessing the user profile or other user specific data stored on a network server and/or local device. The types of information that can be input through the user interface to a user profile may include: basic information (e.g., first name, middle name, last name, aliases, mailing address, state, city, zip, college year, college term, intend to go to college full or part time, citizenship/residency, ethnicity/race, cell phone, telephone, allow text alerts?, current status, etc.), school information (name of school, address of school, name of guidance counselor, AP classes taken, clubs joined, interests, etc.), college preferences (e.g., location, in state/out of state, urban/rural/suburban/online, national/private/public, religious preference, specific religion preferred, acceptance rate, cost/tuition, program of study/departments, classes offered, degrees offered, study abroad, etc.), grades & scores (e.g. average GPA, SAT scores, ACT scores, IQ, etc.), academic honors (e.g., honors program, International Baccalaureate (Finalist & Semifinalist), National Hispanic Recognition Scholar, National Merit (Finalist & Semifinalist), National Merit Commended Student, salutatorian, valedictorian, for international students: three-good student, scholarships, students leader award, class president/monitor, students union/party leader, school representative, class representative, athlete awards, top ten ranked student awards, etc.), sports (e.g., sports in school, sports out of school), extra-curricular or co-curricular activities (e.g., arts [e.g. theater, dance, painting, photography, writing, other creative endeavors], music [e.g. composing, chorus, band (marching, jazz, symphonic, concert, pep, etc.), orchestra, instrument play, ensembles and solo, opera, Chinese opera], volunteering [e.g. Habitat for Humanity, Big Brothers Big Sisters, American Red Cross, shelters, senior living homes], work (e.g., senior care, pet care, newspaper delivery, babysitting, internship, part time work, summer job, etc.), community activities (e.g. community theater, event planning, festival staff, etc.), church activities (e.g., community outreach, helping the elderly, event planning, community suppers, church-sponsored music and athletic programs, teaching or organizing for summer camps and retreats, missionary work, etc.), governance (e.g., school advisory boards, community youth board, prom committee, student council, student government, etc.), media (e.g. work on a television show, movie or publication, blogging and online journaling, literary journal, local newspaper, local television, school newspaper, school radio or television, yearbook staff, etc.), military (e.g. junior ROTC, drill teams and related activities), achievements, hobbies, interests (e.g., advertising, agriculture, animation, architecture, art, big data, biology, business, chemistry, cooking, culture, entrepreneurships, finance, film, gardening, graphic design, genetics, health care, high-tech, history, indoor sports, innovation, internet, medicine, science, music, networking, outdoor sports, philosophy, photography, reading, revolution, social media, travel, video, writing, diversity/minority, skateboarding, language, animal husbandry, crafting, oceanography, landscaping, sailing, ski, skating, performance, wildlife, extraterrestrial exploration, universe, spaceship, robotics), obstacles, awards, background, financial status, ambitions, talents, demographic information, anticipated enrollment time, citizenship, communication preferences, travel (e.g., outside state, outside country, etc.), writing sample, portfolio (e.g., images of artwork, samples of music or writing, etc.), personality assessment and/or tests/inventories, learning style, and the like.

In embodiments, certain profile information may be automatically pulled from social media profiles and the user may be asked to approve the inclusion of the information in their system profile. In other embodiments, a social media index/rating and a summary of the user's social media presence on the web may be added to their user profile. These aspects may include the student answering certain social media questions (Facebook, Twitter, use, etc.) and reviewing their social media presence. Bots may be used to scan for a user's social media presence on the web to automatically add to a user profile. With respect to the social media index/rating, a classification may be calculated of an extent of social media presence. Classifications may include limited social media user, large/medium/small social media follower, large/medium/small social media creator, possibly excessive social media user, web browser used (Firefox, Safari, Opera, etc.), web browser version used, screen size, OS version used, and the like.

Profile data may be used to filter prospective students, and in some embodiments, group students into smaller pools for consideration. Students can be searched by categories, keywords, numerical data (e.g. test scores, GPA, etc.), and the like. Based on what information is included in the student profile, the system may suggest other actions the student may do. This may include suggestions for filling out additional fields they may have left blank in their profile, providing portfolio samples, and the like. Other suggestions may be a list of actions they should take outside the profile application. Some of these suggestions may be based on the college list the student created of colleges in which they were interested.

In some embodiments, based on certain responses or inputs, the user profile may be customized for additional entry of response or inputs to the user profile. For example, if the student indicates that they are a non-US citizen, certain questions or items for input may be filtered out or may be added in, depending on the question or item for input. For example, if the student indicates that they are a non-US citizen, questions related to US-specific academic testing may be filtered out, while questions related to hobbies of significance in the country of citizenship may be added in.

In generating the user profile, students may select categories for themselves. In other embodiments, categories may be selected on the student's behalf based on certain inputs by the student. For example, if the student inputs that they are in the debate club and in a fraternity, they may be given or otherwise labeled with the category “Outgoing”.

In embodiments, certain categories may be grouped together such that if a user has the group of categories assigned to them, they may also be assigned an additional top-level category. For example, if the student inputs that they play field hockey, have a 3.9 GPA, and an 1800 on the SAT, they may be labeled with categories ‘athlete’, ‘high GPA’, and ‘high SAT’, either by themselves or automatically by the system. Based on the category labels ‘athlete’, ‘high GPA’, and ‘high SAT’, they may then be assigned the top-level category of ‘student athlete’. In embodiments, the top-level categories may not be self-assigned by prospective students. Categories and top-level categories may be searchable by college admissions officers in identifying student applicants. Schools may indicate the presence of students with certain categories and top-level categories in their student body so that the categories and top-level categories may be searched by students in identifying a school with a particular or desired student body makeup.

With the wealth of qualitative and quantitative information available about students through self-reporting or databases (both public and private), the question becomes, how can admissions officers take advantage of all of the available qualitative data, in conjunction with the quantitative data, to rapidly identify students of interest? The solution is the system described herein which enables certain qualitative features of users to be quantified for ease of search by admissions officers and other interested third parties. For example, as the user selects certain categories or makes certain inputs to their profile or provides certain responses to questions, each item may be scored by the system. The score per each category, response or input may be pre-set by the host of the system, an admissions professional, a user, or the like. The system may calculate scores per each item, per group of items, or cumulatively for the user. The calculated scores may be used, for example, to rank candidates. Scores for particular items or groups of items may be weighted in forming the cumulative score. College administrators or officers may search by any combination of scores, cumulative scores, individual items, keywords, category labels, top-level categories, and the like. In an embodiment, the system may pre-set scores for individual items.

In an embodiment, the pre-set scores for responses may be set by an admissions officer to identify candidates. Being able to set scores for certain responses may aid admissions officers in identifying candidates they may not have had the opportunity to interview. Further, calculating a score and weighting elements of the score allows even qualitative candidate features to be quantified, and thus searchable, identifiable, filterable, and the like. Such a process of scoring, which may occur, in embodiments, in real-time or near real-time, improves the technological process of and solves the problem of identifying suitable candidates from a vast pool of candidate data (both qualitative and quantitative) that is being continuously updated over the Internet by automatic data population and manual data population.

For example, students may fill out their profiles and each college may custom assign scores to particular items that may be in student profiles. In this way, the student does not have to fill out a new profile or application for each school of interest, rather, each school can interpret the profile differently using their own custom scores. For example, regarding extracurricular activities, certain response choices for the user profile may be: 1) volunteer at a shelter; 2) travel soccer club; 3) chess club; and 4) participate in student government, and the scores per response for a particular school may be 10, 6, 7, and 7 respectively. Another question may be about the user's hobbies with the response choices being: 1) blogging; 2) photography; 3) model cars/rockets; and 4) political canvassing, and the scores per response being 7, 5, 5, and 9 respectively. Candidates who selected ‘volunteer at a shelter’ and ‘political canvassing’ would have the highest cumulative score and would be the highest ranked candidates based on this scoring system. In this example, it may be that the admissions officer was hoping to identify people who were selfless with their time, had convictions they were willing to stand up for, and were confident speaking in a small group setting with strangers (e.g. such as at a person's door where they are canvassing). In this example, the scoring system is in a way a proxy for uncovering these traits in individuals in a rapid fashion without an interview. Continuing with the same example, say a different college admissions officer was reviewing the same user profile but the assigned scores by this college are 6, 9, 7, and 8 for the extracurricular activities, and 9, 4, 8, and 3 for the hobbies. In this scenario, candidates who selected ‘travel soccer club’ and ‘blogging’ would have the highest cumulative score and would be the highest ranked candidates based on this scoring system. Perhaps, the admissions officer is looking for gregariousness in a diversity of settings.

As indicated previously herein, scores for particular items or groups of items may be weighted in forming the cumulative score. One method of weighting may enable admissions officers to diversify their student population in areas by preferentially weighting criteria missing from the current student population. The weighting may be set automatically or according to a manually indicated preference. Automatic weighting may involve first doing an analysis of the admissions officer's school population for to identify criteria/category labels that are missing or disproportionately under-represented but which are represented in the platform's candidate pool.

In an embodiment, the platform may have template quick searches for users to quickly begin executing a search. For example, the quick search may involve just a few selected criteria, which can be further refined as desired. The number of criteria utilized in the quick search or in any search on the platform may be limited or constrained by the makeup of the pool. For example, if certain criteria are not present in the pool, those criteria may be removed the available search criteria. In another example, if the pool is relatively homogenous, the number of constraints used to search may be limited so that a large enough number of candidates can be identified.

As candidates are identified, admissions officers may add identified candidates to a list. Where there are multiple admissions officers for an entity, a master list may be used by the entity so that the admissions officer may be able to switch between their personal list and the master list view. In embodiments, when candidates are identified, adding the candidate to the admissions officer's list also adds them to the entity's master list.

Once candidates are identified by admissions officers or other interested third parties, they may use the platform to communicate interest to the candidate, such as by messaging the candidate, such as by SMS/MMS to a mobile device or push notification from an application running on a mobile device, providing them an offer, and the like, and candidates may likewise use the platform to engage in messaging with admissions officers or other interested parties. Candidates may use the platform to accept or reject the offer or indicate that they are unsure about the offer. The platform may track responses to offers and if there are unaccepted offers or offers that have been ignored, the platform may suggest alternate criteria for identifying appropriate candidates.

One computer-implemented method for providing rankings includes receiving user profile data from a user at a first remote computer. At the first remote computer, a user profile may be accessed to create or update the user profile and analyze it to generate scores, categories and top-level categories. The scores, categories and top-level categories may be transmitted to a second remote computer where an admissions officer or other interested third party may utilize such information to generate rankings or other hierarchical ordering of users. The students may be notified by the first or second remote computer that their user profile has been accessed, analyzed or ranked.

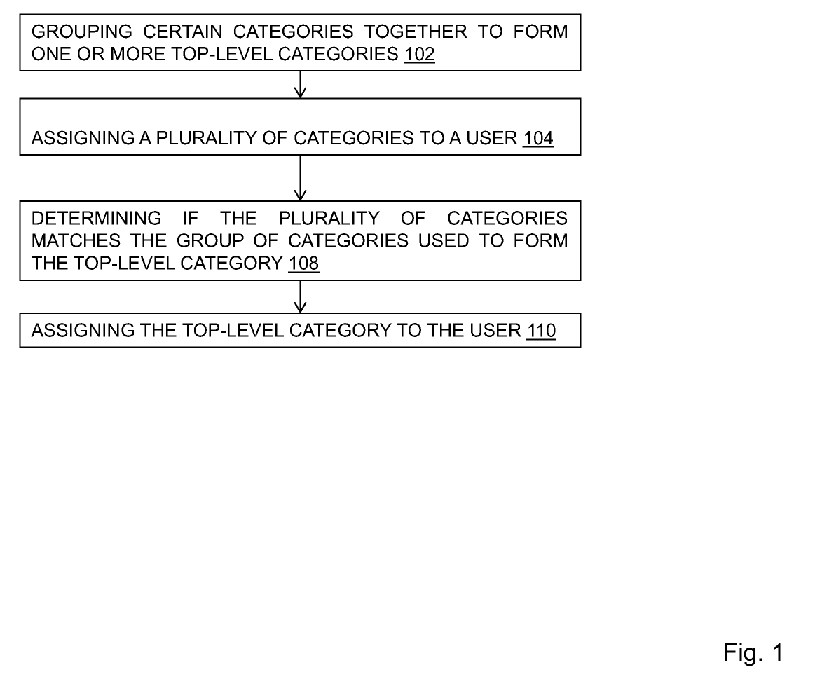

Referring to FIG. 1, a method may include grouping certain categories together to form one or more top-level categories 102, assigning a plurality of categories to a user 104, determining if the plurality of categories matches the group of categories used to form the top-level category 108, and assigning the top-level category to the user 110.

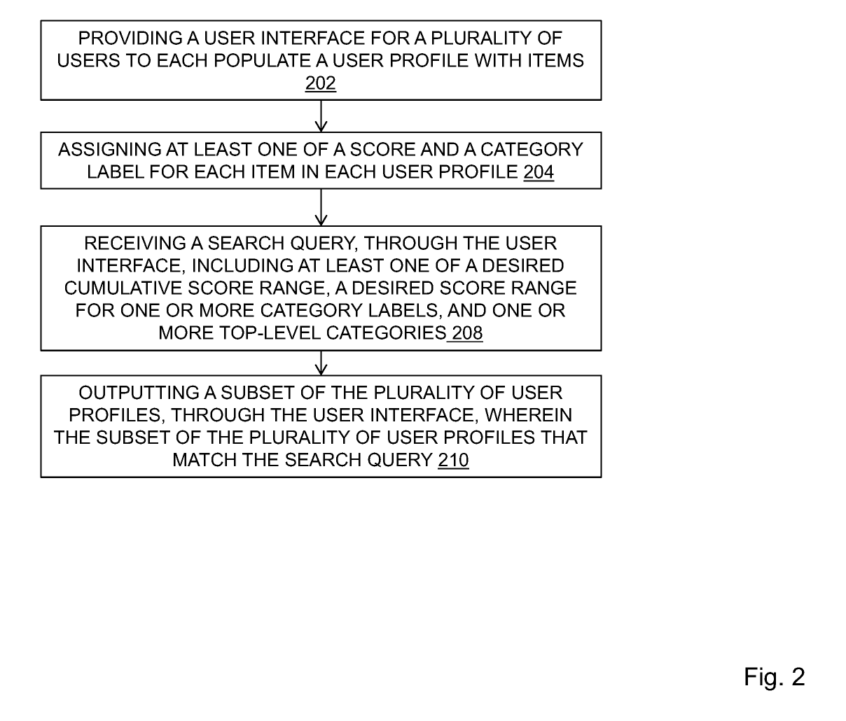

Referring to FIG. 2, a method of matching applicants with colleges may include providing a user interface for a plurality of users to each populate a user profile with items 202, assigning at least one of a score and a category label for each item in each user profile 204, wherein a cumulative score is populated for each user profile by summing individual scores, and wherein a top-level category is optionally assigned for each user profile based on a particular grouping of category labels, receiving a search query including at least one of a desired cumulative score range, a desired score range for a particular, one or more category labels, and one or more top-level categories 208, and outputting a subset of the plurality of user profiles, wherein the subset of the plurality of user profiles that match the search query 210. The user interface is embodied in a tangible medium (e.g., a PDA, smartphone, computer, tablet, mobile device, or other computing device with input and output devices) and is directly and necessarily tied to a computing device. The user interface is accessible on different computing devices and capable of dynamically accessing user specific data stored on a network server and local device.

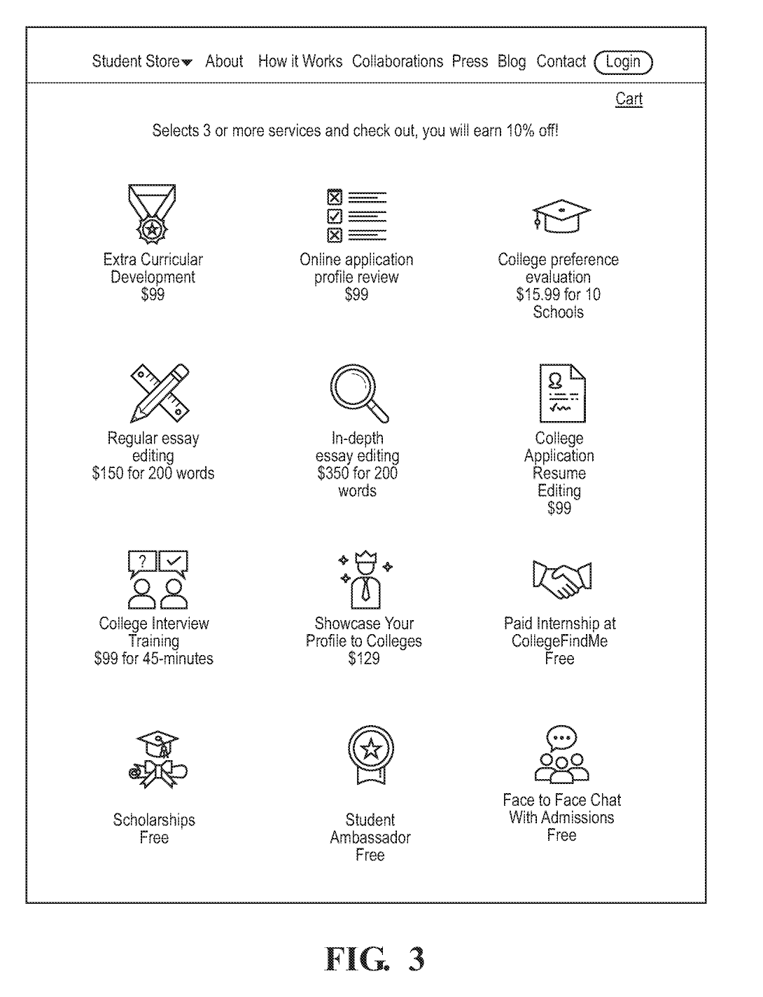

Referring to FIG. 3, services for students may be consolidated into a single marketplace web interface for selecting desired services. For example, services such as Extra Curricular Development, Online college application profile review, College preference evaluation, college application essay editing, In-depth college application essay editing, college Application Resume Editing, College Interview Training, Scholarships, Showcase an applicant's profile to Colleges, Internship opportunities, Student Ambassador opportunities and chat opportunities with college admissions.

Methods described herein may be completed in a time span selected from the group consisting of: less than about 1 minute, less than about 30 seconds, less than about 10 seconds, less than about 5 seconds, less than about 1 second, or substantially instantaneously.

The system may be embodied in a web-based platform with client and server side programming and a database to store information. The platform may operate in the cloud. The stored information may include data tables on colleges and related information from third party sources, such as the Dept. of Education, Carnegie Classification of Institutions College data, and the like. The system may store student profile information provided by users such as on forms or in response to questions. The client side also uses client side languages such as CSS and jquery. Information while using the web platform from both students and college administrators is also saved and used. Web site use patterns may be used to help refine the delivery of the appropriate information to both students and college administrators/officers.

The marketplace catering to both colleges/universities or other entities seeking candidates and student/candidates may be offered to users as a paid service or subscription. In embodiments, consortia or groupings of colleges/universities or other entities seeking candidates may purchase access as a paid service or subscription, such as to offer the service to individual members of the consortia or group. For example, the state of New York may purchase access for offices or recruiters (e.g. admissions office, athletic office, music department, etc.) at all of their state universities to use.

In embodiments, access to the marketplace may be for a pre-defined number of users, a pre-defined number of searches, a pre-defined number of search results, a total amount of time spent searching, a total amount of time, an unlimited amount of time, an unlimited number of searches, search results or use, and the like. Access to the marketplace may be limited to one or more of a certain sub-set of features, all features, searching certain content sets, searching all content sets, a level of functionality, messaging, storing results, search aids, and the like. In embodiments, certain portions of the marketplace may be accessed freely while other portions may be categorized as premium and subject to the paid service/subscription.

In embodiments, colleges, universities, recruiters, programs or other interested entities may access the marketplace as a paid service or subscription. For example, a university may subscribe its admissions office personnel to the marketplace. The personnel may each use an individual login/account or may use a common login/account. The university may subscribe to the marketplace as a complementary source of recruitment to any traditional efforts.

In another example, students/candidates may access the marketplace as a paid service or subscription. For example, individuals may subscribe to the marketplace when they are actively searching for one or more colleges to which they may want to apply.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A tangible article of manufacture having instructions stored thereon that, when executed, cause a machine to perform operations comprising:
providing a user interface in a marketplace for a plurality of candidates to each populate a user profile with data items, wherein each candidate separately subscribes to the marketplace and a plurality of user profiles are populated;
assigning a score and a category label for each data item in each user profile, wherein a cumulative score is populated for each user profile by summing individual scores and wherein at least one top-level category is optionally assigned for each user profile;
receiving a search query, through the user interface, including at least one of a desired cumulative score range, a desired score range for one or more category labels, and one or more top-level categories; and
outputting a subset of the plurality of user profiles, through the user interface, wherein the subset of the plurality of user profiles match the search query.

2. The tangible article of manufacture of claim 1, further comprising, ranking the plurality of user profiles in accordance with at least one of the cumulative score range, the score range or the top-level categories to obtain a ranking.

3. The tangible article of manufacture of claim 1, wherein the plurality of user profiles comprises qualitative and quantitative information.

4. The tangible article of manufacture of claim 2, further comprising, enabling communication with one or more users based on the ranking of the user's user profile.

5. The tangible article of manufacture of claim 1, wherein the top-level category is identified by determining if the category label that was assigned matched a group of categories used to form the top-level category.

6. The tangible article of manufacture of claim 1, wherein assigning the score to data items is done through the user interface by an entity that provided the search query.

7. The tangible article of manufacture of claim 1, wherein the search query is based on category labels that are missing or disproportionately under-represented in a third-party group but which are represented in the plurality of candidates.

8. The tangible article of manufacture of claim 4, wherein enabling communication is limited by a rule for accessing the marketplace.

9. The tangible article of manufacture of claim 8, wherein the rule for accessing the marketplace relates to one or more of a pre-defined number of users, a pre-defined number of searches, a pre-defined number of search results, a total amount of time spent searching, a total amount of time, an unlimited amount of time, an unlimited number of searches, an unlimited number of search results, one or more of a certain sub-set of features, searching certain content sets, a level of functionality, a level of messaging, a level of storing results, and a level of search aid.

10. A computer-implemented system comprising:
a user interface in a marketplace structured for a plurality of candidates to each populate a user profile with data items, wherein each candidate separately subscribes to the marketplace;
a processor structured to assign a score and a category label for each data item in each user profile, wherein a cumulative score is populated for each user profile by summing individual scores and wherein at least one top-level category is optionally assigned for each user profile;
wherein the processor receives a search query, through the user interface, comprising at least one of a desired cumulative score range, a desired score range for one or more category labels, and one or more top-level categories;
wherein the processor outputs a subset of the plurality of user profiles, through the user interface, wherein the subset of the plurality of user profiles match the search query;
wherein the processor ranks the user profiles in accordance with at least one of the cumulative score range, the score range or the top-level categories to obtain a ranking; and
wherein the search query is based on category labels that are missing or disproportionately under-represented in a third-party group but which are represented in the plurality of candidates.

11. The computer-implemented system of claim 10, wherein the user profile comprises qualitative and quantitative information.

12. The computer-implemented system of claim 10, wherein the processor enables communication with one or more users based on the ranking of the user's user profile.

13. The computer-implemented system of claim 10, wherein the top-level category is identified by determining if the category label that was assigned matches a group of categories used to form the top-level category.

14. The computer-implemented system of claim 10, wherein an entity that provided the search query assigns the score, using the processor, to data items through the user interface.

15. The computer-implemented system of claim 12, wherein communication is limited by a rule for accessing the marketplace.

16. The computer-implemented system of claim 15, wherein the rule for accessing the marketplace relates to one or more of a pre-defined number of users, a pre-defined number of searches, a pre-defined number of search results, a total amount of time spent searching, a total amount of time, an unlimited amount of time, an unlimited number of searches, an unlimited number of search results, one or more of a certain sub-set of features, searching certain content sets, a level of functionality, a level of messaging, a level of storing results, and a level of search aid.
